(19) United States
(12) Patent Application Publication
(10) Pub. No.: US 2015/0162997 A1
(43) Pub. Date: Jun. 11, 2015

(54) METHODS FOR STREAMING RADIO CONTENT

(71) Applicant: urRadio Group, LLC, WILMINGTON, DE (US)

(72) Inventors: Tyler M. FRANCOIS, HAZELHUST, WI (US); Nicola MARZOLLA, VENICE, CA (US); Pier STABILINI, SANTA MONICA, CA (US); Hector AMEZQUITA, JR., WHITTIER, CA (US)

(21) Appl. No.: 14/566,064

(22) Filed: Dec. 10, 2014

Related U.S. Application Data
(60) Provisional application No. 61/914,075, filed on Dec. 10, 2013.

(51) Int. Cl. H04H 20/82; H04H 60/04

(52) U.S. Cl. CPC H04H 20/82; H04H 60/04

(57) ABSTRACT

Streaming radio content includes providing radio content to a stream agent. A playlist is arranged corresponding to the content, which includes optionally modifying portions thereof. The stream agent transmits firstly, multiple streaming radio channels to a server cluster, each of which corresponds to part of the content, based on the arranged playlist and including the optionally modified content. The server cluster transmits secondly, the first-transmitted radio streaming channel to websites and/or mobile applications, which are configured to play it. A DJ may modify the content and arrange the playlist.

### CROSS REFERENCE TO RELATED U.S. APPLICATIONS

The present Application claims priority to co-pending related U.S. Provisional Patent Application No. 61/914,075 filed Dec. 10, 2013 by Tyler Francois, et al. for “Methods for Streaming Radio Content,” which is incorporated by reference in its entirety and is assigned to the Assignee of the present Application.

### FIELD

The present disclosure relates to digital radio broadcasting. More particularly, it relates to methods and systems for streaming radio content.

### BACKGROUND

Streaming radio comprises audio services, which are transmitted over the Internet. Audio content streamed over streaming services may comprise any and all genres of music, as well as talk, news and other content similar thereto. Streaming radio may also be referred to as webcasting, and/or web or net radio, among other terms. These terms may be used herein synonymously and/or interchangeably.

### SUMMARY

In a first aspect of the disclosure, a method to stream radio content is described, the method comprising: providing, by a computer, radio content to a stream agent; arranging, by the stream agent, a playlist with the radio content; transmitting, by the stream agent, a radio streaming channel to a server cluster, wherein the radio streaming channel is based on the playlist; and transmitting, by the server cluster, the radio streaming channel to a website or mobile application, wherein the website or mobile application is configured to play the radio streaming channel. Aspects of the disclosure also relate to other streaming methods, streaming systems and/or communication networks.

Streaming radio content includes providing radio content to a stream agent. A playlist is arranged corresponding to the content, which includes optionally modifying portions thereof. The stream agent transmits firstly, multiple streaming radio channels to a server cluster, each of which corresponds to part of the content, based on the arranged playlist and including the optionally modified content. The server cluster then transmits secondly, the first-transmitted radio streaming channel to websites and/or mobile applications, which are configured to play the content. A DJ may modify the content and arrange the playlist.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure. In the figures:

FIG. 1 illustrates an exemplary process flow for streaming radio content;

FIG. 2 illustrates an exemplary hardware architecture for streaming radio content in accordance with the process flow of FIG. 1;

FIG. 3 depicts an exemplary embodiment of a target hardware for implementation of an embodiment of the present disclosure;

FIG. 4 depicts a flowchart for an example computer-implemented process for streaming radio content;

FIG. 5 depicts an example stream agent, according to an embodiment of the present disclosure;

FIG. 6 depicts an example SPM Engine, according to an embodiment of the present disclosure; and

FIG. 7 depicts an example communication network, according to an embodiment of the present disclosure.

### DETAILED DESCRIPTION

An example embodiment of the present disclosure is described in relation to a computer-implemented method for streaming radio content. The method comprising providing a body of radio content to a stream agent. A playlist is arranged with the stream agent. The playlist corresponds to one or more portions of the provided radio content body, wherein the arranging the playlist step comprises optionally modifying at least one of the portions of the radio content body. The stream agent transmits firstly a plurality of streaming radio channels to a server cluster. Each of the plurality of streaming channels corresponds to one of the portions of the radio content body, based on the arranging the playlist step, and comprising the optionally modified radio content body. The server cluster transmits secondly the first-transmitted radio streaming channel to one or more of a website or mobile application. The one or more websites or mobile applications are configured to play the radio streaming channel. One or more users of the radio content body provided with the stream agent (who may include at least one DJ) may perform the arrangement of the playlist.

An example embodiment of the present disclosure relates to a computer network based system for streaming radio content. The system comprises a provider component operable for providing a body of radio content and a stream agent. The stream agent is operable for receiving the provided radio content body, for arranging a playlist corresponding to one or more portions of the received radio content body wherein the stream agent, while operating to arrange the playlist, is further operable for optionally modifying at least one of the portions of the received radio content body, and for first-transmitting a plurality of streaming radio channels, each of the plurality of streaming radio channels based on the playlist arranged in relation to the corresponding radio content portion, and comprising the optionally modified radio content body. The system also comprises a plurality of servers arranged as a cluster. The server cluster is operable for receiving the first-transmitted plurality of streaming radio channels, and for second-transmitting each of the streaming radio channels to one or more of a website or mobile application, wherein the one or more websites or mobile applications are configured to play one or more of the streaming radio channels.

An example embodiment of the present disclosure relates to a communication network configured for streaming radio content. The communication network comprises a first subnet (sub-network), a second subnet, and a third subnet. The first subnet comprises a content provider operable for providing a body of radio content and a stream agent communicatively coupled thereto and operable for receiving the provided radio content body, for arranging a playlist corresponding to one or more portions of the received radio content body. The stream agent, while operating to arrange the playlist, is further operable for optionally modifying at least one of the portions of the received radio content body, and for transmitting firstly a plurality of streaming radio channels, each of the plurality of streaming radio channels based on the playlist arranged in relation to the corresponding radio content portion and comprising the optionally modified radio content body. The second subnet comprises a first plurality of servers arranged in a cluster and a radio service. The second subnet is operable for broadcasting a plurality of streaming radio channels, each corresponding to at least one of the radio content body portions, to one or more websites or mobile applications, the one or more websites or mobile applications configured to play one or more of the streaming radio channels. The third subnet comprises a second plurality of servers arranged in a cluster and a pre-radio service. The third subnet is operable for modifying one or more of the streaming radio channels with an optional modification added by a user of the third subnet in at least near real time relative to the one or more streaming radio channels. The third subnet is further operable for providing the optionally modified streaming radio channels to the second subnet.

In the present disclosure, methods and systems for broadcasting radio through digital streaming are described. These methods can allow broadcasting a great number of channels, each with a different playlist. Each channel may be transmitted to a great number of users. The playlist may be modified by the system to comprise a desired list of songs or other musical pieces, and may comprise advertisements. Songs may be played in a stream with no pauses in between, or the stream may comprise pauses. In some embodiments, songs can be mixed so that there is a smooth transition between songs. In the present disclosure, the term ‘song’, ‘musical content’, or ‘music’ may refer to any kind of musical piece of any kind of musical genre, such as pop songs or classical musical symphonies. More generically, ‘content’ may refer to musical content or advertisements, or other media content suitable for radio streaming. For example, talk show or news broadcasts may also be part of a stream. A stream may comprise audio and/or video content.

Streaming radio comprises audio services, which are transmitted over the Internet. Audio content streamed over streaming services may comprise any and all genres of music, as well as talk, news and other content similar thereto. Streaming radio may also be referred to as webcasting, and/or web or net radio, among other terms. These terms may be used herein synonymously and/or interchangeably.

Streaming radio presents continuous streams of audio content. Unlike podcasting technology, streaming radio may be “tuned” in without downloading of related content files as such. Moreover, the streams are continuous in the sense that, unlike web-based on-demand sharing of audio files, the streams resemble audio media broadcast by radio transmission over the public airwave frequencies, and may not be replayed, paused or otherwise interrupted without terminating the continuous audio stream.

Streaming radio typically uses data compression technologies characteristic of a variety of lossy audio codecs (compressor/decompressor, compander/decompander, and/or coder/decoder, interchangeably). Upon compression, audio data packets are streamed over one or more local networks and/or the internet. Streaming typically involves continuous serialized transmission in TCP (Transport Control Protocol) packets or packets that comport with UDP (User Datagram Protocol). The TCP packets are reassembled in serial order by a receiver, decoded and played, typically with a lag, which comprises a delay on the order of a few seconds in relation to the transmission of the stream.

Streaming services conventionally stream the music or other audio content simply to end user listeners. While conventional streaming approaches allow users to customize their listening experiences, such as by creation of user playlists or the like, they lack the capability to allow additions, such as a live voice or related “disk jockey” (DJ) inputs, to their current music or other audio content streams. The users of conventional streaming radio must thus incur the expenses and complexity associated with procuring and integrating one or more custom devices to effectively build their own radio stations, having a unique format with, for example, voice from a DJ and/or various other effects mixed over their music streams (or other audio content).

In contrast to an embodiment of the present disclosure, typical conventional streaming services simply stream music and/or other content to end user listeners. Some conventional streaming services tout their ability to customize users' experience therewith by creating playlists related to the audio content. Unfortunately however, they typically lack the capability for users to modify the streamed content, for instance with the addition of a live voice from a DJ or other effects (e.g., fades and/or filtering) to their content streams, for building user-customized radio channels therewith. At least without significant customization applications and expenses, effort and added complexity associated therewith, conventional streaming services offer no solution allowing users to build their own radio stations, e.g., with voice mixed over music from a DJ and/or other effects.

Example embodiments described in the present disclosure allow users to customize their experience with streaming radio by creating playlists related to content thereof, which allow the users to optionally modify the content. For instance, example embodiments allow users to add voice overs and other effects to streaming content and thus, to build their own customized radio stations for streaming unique content, which is modified in relation to the original content.

In some embodiments, the playlist of a channel is created or edited by a DJ. The DJ may create a channel with a desired playlist, and may include comments in between or during a song. The DJ comments may be pre-recorded prior to broadcasting, or they may be live during broadcasting. The broadcasting itself may be live, or it may be recorded and broadcasted at a later time. The DJ may insert a number of advertisements during broadcasting of a channel, or the advertisements may be pre-included in the content provided to the DJ.

In an example embodiment described in the present disclosure, radio content is streamed. The radio content is provided to a stream agent by a computer. The stream agent arranges a playlist using the provided content. A streaming radio channel, which is based on the arranged playlist, is simply streamed (e.g., as-is, without modification), and thus transmitted by the stream agent to a server cluster. The server cluster then transmits the radio streaming channel to a website or a mobile application, which are configured to play the radio streaming channel. In arranging the playlist, the stream agent may also optionally modify the content, e.g., with voice over or effects. An embodiment is operable for streaming the content thus modified.

Example embodiments of the present invention are interoperable simply with a variety of computers including PCs and/or smartphones, tablets and various other mobile devices. Example embodiments allow users, including disk jockeys (DJs) with a PC or other computer or a mobile device, to mix voice, effects and/or other modifications, over music or other content in audio streams, and to re-stream the resulting modified audio content as a unique radio station to a radio service.

The mixing is done live in near real time over the music or other audio content that is streaming from a pre-radio service. The radio service provides at least two streaming services. One of the streaming services is used by a DJ, commentator or similarly situated user. As used herein, the term DJ may refer to a disk jockey, commentator, educator, newscaster, sportscaster, announcer or any other similarly situated user. The received stream may be modified by the user with a mix over and the resulting modified audio content re-streamed to other end user listeners.

Streaming radio content includes providing radio content to a stream agent. A playlist is arranged corresponding to the content, which includes optionally modifying portions thereof. The stream agent transmits firstly, multiple streaming radio channels to a server cluster, each of which corresponds to part of the content, based on the arranged playlist and including the optionally modified content. The server cluster transmits secondly, the first-transmitted radio streaming channel to websites and/or mobile applications, which are configured to play it. A DJ may modify the content and arrange the playlist.

An example embodiment of the present disclosure relates to a computer-implemented method for streaming radio content. The method comprising providing a body of radio content to a stream agent. A playlist is arranged with the stream agent. The playlist corresponds to one or more portions of the provided radio content body, wherein the arranging the playlist step comprises optionally modifying at least one of the portions of the radio content body. The stream agent transmits first a plurality of streaming radio channels to a server cluster. Each of the plurality of streaming channels corresponds to one of the portions of the radio content body, based on the arranging the playlist step and comprising the optionally modified radio content body. The server cluster transmits second the first-transmitted radio streaming channel to one or more of a website or mobile application. The one or more websites or mobile applications are configured to play the radio streaming channel. One or more users of the radio content body provided with the stream agent (who may include at least one DJ) may perform the arrangement of the playlist.

Example embodiments relate to a codec-agnostic streaming architecture, which is independent of any particular codec and operable with any streaming-suitable codec. An example embodiment may be implemented with a server side infrastructure that uses the following codecs, protocols, libraries and/or tools:

FFmpeg for handling transcoding;

Sox library/tool for converting streams to 432 Hz server side audio;

Software (e.g., written in Java® or related code) for handling mixing and fade effects;

Codecs built-in with the FFmpeg library and other codecs or libraries, including Ogg Vorbis, MP3 and/or AAC; and

Protocols built-in FFmpeg library as well as other protocols from other libraries, including Real Time Message Protocol (RTMP), HyperText Transfer Protocol (HTTP), HTTP Live Streaming (HLS), Real Time Streaming Protocol (RTSP), and/or Icecast.

Conversion to 432 Hz may be implemented in the Stream-Agent and/or in the streamer/player/mixer and/or Mobile applications using a library and the Sox tool.

An example embodiment may be implemented in which a radio service delivering content to end users performs a live transcoding on-codec or on-protocol.

In some embodiments of the present disclosure, music is provided by a content provided. A content provided may comprise an aggregation of content provided by other content providers. In one embodiment, the musical content is provided by music provider (e.g., 7Digital®).

The audio content provided by the content provider, such as 7Digital®, may be transmitted through an appropriate transmission protocol between servers, as understood by the person skilled in the art. For example, real-time messaging protocol (HTTP/HTTPS) may be used to transmit musical content from the content provider's servers to a stream agent. The protocol may comprise RTMP with one or more other streaming providers, such as Icecast.

The stream agent can receive the musical content, as well as any advertisement content, and can create streaming channels which are then made available to a cluster of computers (such as a cluster of servers). The cluster of servers may subsequently transmit the streaming channels to a streaming provider.

The streaming provider, in some embodiments, may be a company specialized in streaming content to a great number of users. Therefore, the streaming channels created by the stream agent are made available to any user who connects to a streaming radio.

For example, a website may host a streaming radio channel, or more than one channel. For example, a user may select a country music channel on a streaming radio website. The stream agent has received a collection of country songs from a content provider such as music provider (e.g., 7Digital®). The stream agent has further arranged a playlist with the collection of country songs. Such a playlist may be arranged through a number of criteria such as artist name, music subgenre, year of publication, and so on.

The playlist with country songs arranged by the stream agent is received by a streaming radio provider. In some embodiments, the streaming radio provider comprises Wowza®. Wowza® renders the stream available through a number of servers, or a cluster. In such a way, the streaming radio channel with country songs is made available to the streaming radio website where the user has selected to listen to a streaming radio channel with a country song theme or playlist.

For example, an end-user may listen to the streaming radio through a variety of players based on Flash, Silverlight, HTML 5, iOS, Android, or others. The end user may listen to a streaming radio on a website. The website may comprise a player, or the player may run on the end user's device while being configured to receive the stream from the website. The player may operate in a computer, such as a desktop, or a tablet or a smartphone, or a portable MP3 player with Internet access.

The streaming architecture of the present disclosure is based on a live stream repeater approach for scalability, which is a method for delivering a single live stream to many viewers across a deployment comprising multiple servers. The setup can use an origin/edge configuration where the source stream is published to an origin server, that is a custom built “stream agent” server based on open-source software, and the stream is made available for playback on multiple edge servers. Wowza® can be used for the edge servers although other streaming providers such as NGINX® may be used.

For example, using Wowza® the following protocols may be employed: RTMP, HLS (HTTP live streaming), HDS, MS-WMSP, or RTPS. Such protocols are known to the person skilled in the art. A description can be found, for example, on:
http://en.wikipedia.org/wiki/Real_Time_Messaging_Protocol,
http://en.wikipedia.org/wiki/HTTP_Live_Streaming,
http://en.wikipedia.org/wiki/Microsoft_Media_Server, http://www.adobe.com/products/hds-dynamic-streaming.html, and
http://en.wikipedia.org/wiki/Real-Time_Publish-Subscribe_(RTPS)_Protocol, the disclosure of all of which is incorporated herein by reference in their entirety.
When proxing a stream from a music provider (e.g., 7Digital™®) to the stream agent, an HTTP/HTTPS stream is received and is processed server-side as described in the following. The protocol may comprise RTMP with one or more other streaming providers.

The stream is at first passed to the FFMPEG. The FFMPEG is a software that will be known to the person skilled in the art, and a description can be found, for example, in http://en.wikipedia.org/wiki/FFmpeg, the disclosure of which is incorporated herein by reference in its entirety. FFMPEG decodes it to raw format PCM stereo 16 bit 44 kHz (server). Filters may be applied to the stream in real time. For example, a fade in/out filter can be applied, which mixes the first five (server) seconds of the next stream over last five seconds of current stream. Other filters or effects may comprise instant mixing streams and insert advertising.

FFmpeg encodes the stream in MP3 44.1 kHz 128 kbit or in Ogg Vorbis. Other formats may be supported such as AAC/256 kbit.

### User Streaming Flow

Depending on who is receiving the stream broadcasted from the stream agent, there are two scenarios: one comprises Live Mic stations, and the other does not. A Live Mic can be, for example, a microphone configured to be used by a DJ.

Live Mic Stations (online stations with live Mic mixing):

A user DJ goes live with the Mic (or with a DJ Console). The following are some example steps involved in pushing the stream from the stream agent to the DJ and back to the origin/edge servers for broadcasting:
a. The stream is pushed to the Pre-Radio Service from the stream agent over RTMP and/or Icecast Protocol using FFMPEG.
b. The stream is then sent from Pre-Radio Service to the DJ streamer/player/mixer in RTMP and/or Icecast Protocol (server/client). The streamer/player/mixer (SPM) may comprise an SPM engine. The SPM engine may comprise a Java® Applet. The SPM engine may also comprise a JavaScript® program, which leverages a Web Audio Data API and/or a native mobile or PC (e.g., desktop) program.
c. The SPM engine decodes the stream to raw format PCM stereo 16 bit 44 kHz (client).
d. The SPM Engine applies effects and mixes the DJ voice (or tracks).
e. The SPM Engine encodes the mixed result to mp3 44.1 kHz 128 kbit or other encoding such as AAC format and 256 kbit.

The pre-radio service may comprise a standard decoder. The pre-radio service may operate similar to the operation of the radio service, but may typically serve fewer users.

The SPM Engine, which now acts as the Origin, can stream to the Radio Service via RTMP and/or Icecast Protocol. SPM engines (e.g., Applets, etc.) are known to the person skilled in the art. The SPM Engine comprises software code, which may be written in Java® or a related or similar language. The stream is then sent from Pre-Radio Service to the DJ streamer/player/mixer in RTMP and/or Icecast Protocol (server/client). The streamer/player/mixer (SPM) may comprise an SPM engine. The SPM engine may comprise a Java® Applet. The SPM engine may also comprise a JavaScript® program, which leverages a Web Audio Data API and/or a native mobile or PC (e.g., desktop) program.

The SPM Engine allows mixing and other modifications and publishing the mixed music or otherwise modified content to a server. The SPM Engine receives the music stream from the Pre-Radio-Service, and simultaneously in relation thereto records an audio voice signal from a microphone. The SPM Engine mixes the two signals (music and/or other content and voice) and compresses the result using an audio codec such as Mp3, AAC, or Ogg Vorbis. A packetizer then packetizes the compressed audio result for transmission using one or more of the RTMP, HTTP, RTSP, or Icecast protocols.

Radio Service can then broadcast the stream to tuned-in listeners. The stream may also be pushed to a content delivery network (CDN) from edge servers. While the CDN obviates the need to provide management over a large number of servers, which each then in turn manage many end user listeners, the final experience of the end users may not be affected significantly without its use.

No-Mix Stations (Offline or Online stations with no live Mic Mixing)

For radio stations that are only streaming music (no Mic mixing), the flow is simpler and does not involve the client SPM engine. The SPM engine may comprise a Java® Applet, a JavaScript® program, which leverages a Web Audio Data API, and/or a native program for mobile or PC (e.g., desktop) platforms.

.Playback radio with no mixing or other content modifications may avoid processing in the DJ SPM Engine. Instead, the streaming-music or other content is managed from the Stream-Agent service (e.g., play songs through an all-playlist).

The stream is pushed to the Radio Service from the stream agent over RTMP and/or Icecast Protocol using FFmpeg.

Radio Service can broadcast the stream to tuned-in listeners. The stream may also be pushed to a CDN from edge servers. Again, the CDN obviates the need to provide management over a large number of servers, which each then in turn manage many end user listeners. However, the final experience of the end users may not be affected significantly without use of the CDN.

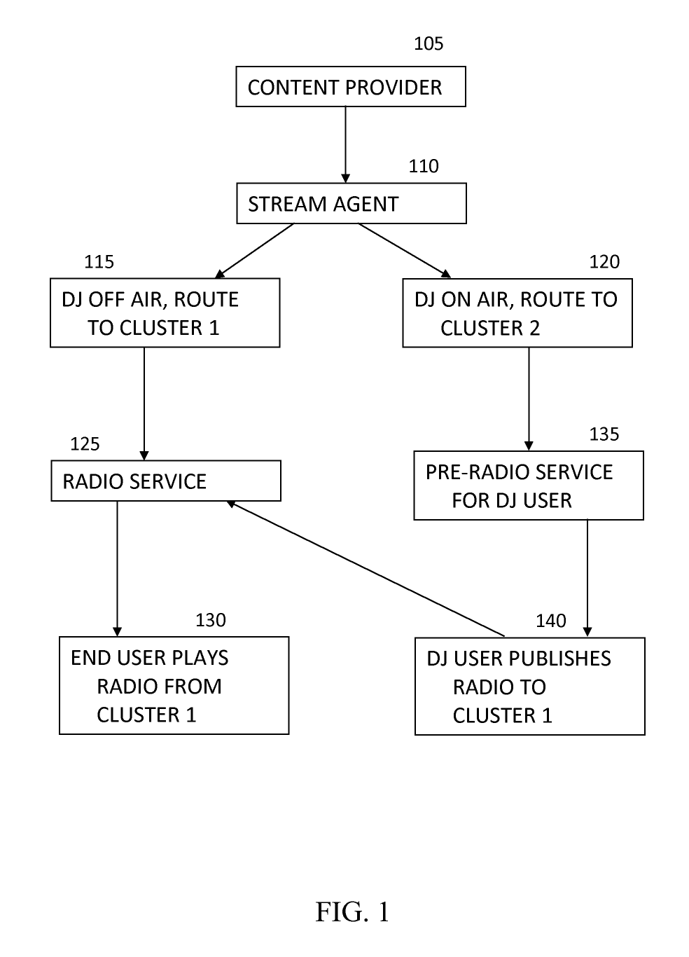

FIG. 1 illustrates an example embodiment of the present disclosure. Music and/or other audio content (e.g., from 7Digital®) is transmitted, for example according to the HTTP/HTTPS protocol, from a content provider (105) to the stream agent (110). The protocol may comprise RTMP with one or more other streaming providers, such as Icecast.

The stream agent (110) may convert RTMP and/or Icecast Protocol MP3 content into raw, apply effects or filters, mix, and then re-encode in RTMP and/or Icecast Protocol MP3. Such conversion may be implemented through a standard conversion software which will be known to the person skilled in the art and therefore is not described in details.

The stream may be transmitted from the stream agent (110) to a first cluster of servers (115) for the case where no DJ is present. A cluster of server comprises a set of servers, comprising one or more servers. The stream agent (110) may also transfer the stream to a second cluster (120) for the case where a DJ is present.

The stream may be transferred from the first cluster (115) to a radio streaming service (125), such as a Wowza® or Icecast cluster. This stream is then made available to end users through a variety of players (130) based on Flash, Silverlight, HTML 5, iOS, Android, or others.

An example embodiment may be implemented wherein Wowza® is not used as the Stream-Agent, which instead comprises software that can handle the RTMP and/or Icecast protocols. Wowza® is used as a streaming server for Radio-Service and Pre-Radio Service. Icecast may also be used as streaming server, which allows use of the OGG Vorbis codec.

The stream may also be transferred from the second cluster (120) to the pre-radio service for DJ users (135). The DJ may then make the radio stream available to end users (140). Alternatively, the DJ user may render the radio stream available to a radio streaming service (125), which then makes it available to end users through a variety of players (130).

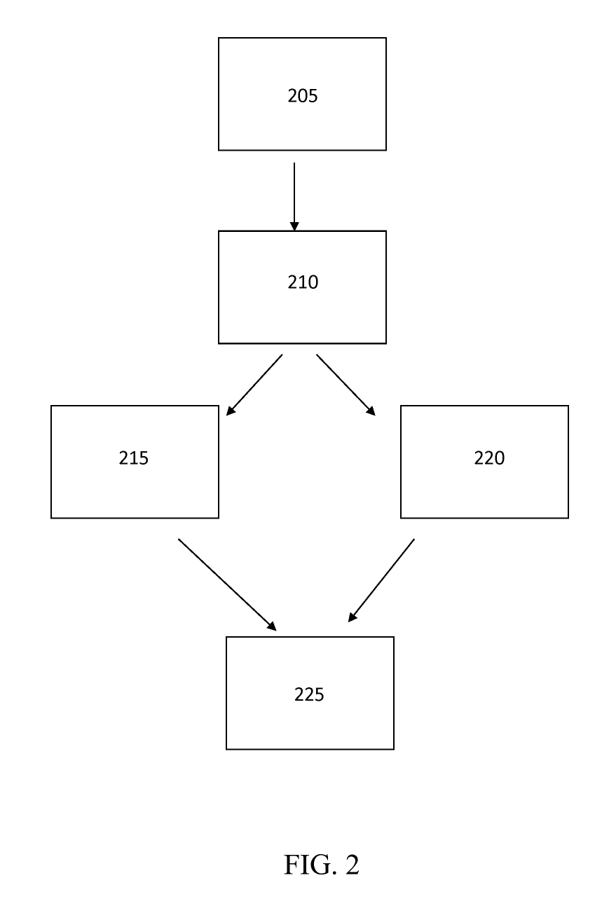

FIG. 2 illustrates an exemplary hardware system embodiment of the present disclosure. A server (205) may transmit content to a stream agent computer (210). The stream agent computer (210) may decode, encode, filter and apply effects to the content, as well as insert advertisement in the content. The stream agent computer (210) may then transmit the stream to either a first cluster of servers (215) for the case with no DJ, or a second cluster of servers (220) for the case with a DJ. The first or second cluster of servers (215, 220) may then transmit the stream to a computer (225) that makes it available to end users.

In some embodiments, a cluster of servers, as discussed above, may also transmit the radio streaming channel to a mobile application instead of a website, or both to a website and a mobile application. In such a way, users with a mobile device such as a tablet or cellphone (such as a smartphone) may be able to listen to the radio streaming channel through the mobile application instead of through the website.

In some embodiments, the stream agent and the SPM Engine, mentioned above, are both based on a similar mixer. Stream mixing is done by code written in Java®. The SPM engine may also comprise a JavaScript® program, which leverages a Web Audio Data API; and/or a native program for a mobile or PC (e.g., desktop) platforms.

The mixer may be operable in real time without significant latency. The mixer may thus provide a quality of experience on a par with Voice over Internet Telephony (VoIP).

One mixer is the DJ Client, the SPM engine of which runs on the user browser as, e.g., a Java® Applet. Mixer related code may also be written in JavaScript®, such as a JavaScript® program (that leverages a Web Audio Data API). For PC (e.g., desktops and others) and/or mobile and tablet devices may use a native functionality, e.g., specific to the device, can be used to implement the SPM Engine. The stream agent mixer may use the same SPM engine codebase as the client.

Another mixer comprises the Stream Agent code (e.g., a Java® service application), which runs in a server.

The mixer can combine two or more input audio streams in one unique output audio stream. Every mixer could “virtually” support many audio input streams.

The Mixer can work internally with the PCM 16 bit 2 channel 44100 Hz format for input and output.

Any incoming input format is converted before the stream sample is queued to the mixer.

Mainly the mixer combines multiple streams to be unified in a stream, and it can control audio volume levels.

An incoming stream can be in any format that can be decoded to PCM/16/2/44100 before it is passed to the mixer. Once the stream is processed by the mixer it's encoded back in the different formats that are needed for the application. The mixer may always be operable as a consumer and producer, and function with queues.

In some embodiments, the mixer is a thread that works as a consumer and a producer.

It consumes samples from many queued streams (one queue per stream). In the mixer input there are audio streams, such as: encoded streams (mp3, AAC, silk) received from the music provider or stored in a local computer. These can be decoded in PCM 16/2/44100 and pushed in a queue (every stream has a referenced queue); raw streams (microphone, line-input) which are pushed directly in their queue.

In some embodiments it is possible to listen to every stream before the mixer. In these embodiments, every stream could have two queues, one for the mixer and one for the local sound output.

For example the DJ is mixing on the browser or mobile application, therefore the DJ may desire to listen to the stream before it is input to the mixer. To do that, the stream can be sent to two queues, the input queue for the mixer and the output queue for local sound.

The mixer's main thread loops through the pool of active queues and combines every sample that it reads. On every loop, the mixer reads all the samples of the active queues; queues that do not have samples are skipped. When the mixer has read the samples, it can combine all of them into a unique sample. The final sample can then be pushed in one or two output queues, one for the encoder/streamer process and one for local sound output if necessary. The encoder/streamer thread takes the sample from the output queue and encodes it in specified format (mp3, AAC) then streams it to the cluster which will stream it to the user.

The mixer architecture is very simple and scalable using the queue approach different tasks can be performed on the stream in parallel. If a different output needs to be added, it is sufficient to add an output queue and another encoder/streamer thread. (An example would be to audio outputs mp3 and AAC).

### User Monetization Models

In some embodiments, advertisements may be inserted in a stream. For example, users can monetize their digital content and earn profits. A user can set his/her station to only be accessible by a user if they pay a monthly subscription or user(s) can set a premium charge based on a pay-per-listen (single event) live broadcast. Both monthly subscriptions and pay-per-listen events may or may not contain music. For example, Talk Radio Shows or Video Streams.

### Monthly Subscription Model:

User(s) can set a monthly (30 day) subscription fee to their station and earn directly from users who want to access their content, tune into that user/station live or listen to that user's station on shuffle (user is Off Air, but paying users can still access and listen to that user's/station's playlist).

Monthly subscription fees are set by the users themselves and can vary, for example, between $0.25 and $10.00/month, in increments of ($0.05). Earnings can be distributed to the user(s) based on a Revenue Share Program and the user(s) balance/earnings report can be viewed anytime by clicking Balance in a drop-down account menu tab.

### Pay-Per-Listen (PPL):

Users can charge, for example, anywhere from $0.25 to $200.00 for Pay-Per-Listen live broadcasts.

A PPL is a single one-time event the user/station holds without having a monthly subscription. User may also have a monthly subscription set, and can also create and hold a PPL event. In both cases, the user can select their own pricing.

### Live Video Feed:

User/stations may also use a Live Video Feed to stream events and or personally engage with their audience. The video may be recorded by webcam and streamed in sync with the mixed audio. RTMP and/or Icecast Protocol are used to deliver the stream to the end user listener.

### Funds Withdrawal:

The revenue share program may pay, for example on a monthly basis, 50% of the gross earnings of any monthly subscription fees and/or pay-per-view live broadcast events (If the user exceeds the minimum withdrawal limit). User may accrue a withdrawal fee, dependent on the type of withdrawal and users location.

### Advertiser Created/Uploaded Geo-Targeted Advertising Campaign API for Internet Radio, Online Radio, Web Radio

The present disclosure may also comprise a geo-targeted commercial software application that allows both local business and large corporations to easily upload their own, or produce a custom audio, visual commercial, or placement ad campaign around their business. Placement, commercial and or audio advertisements can be displayed/voiced to listeners within selected characteristics set by the advertiser. A geo-targeted commercial software may comprise the use of user location information, for example based on an Internet address, a GPS location, or a location information otherwise provided by a user, such as through a zip code.

### Audio Advertisements:

Audio advertisements can be played between songs and the stream player may also display an ad image for users to click on. The stream agent mixer may also be programmed to mix in audio advertising, jingle messages or the like at some point of a song or other content.

### Commercial Advertisements:

Commercial advertisements can be played between songs containing a motion or video.

### Placement Advertisement:

Placement advertisements comprise still images and/or text that are displayed in the listener's browser.

### Creating an Advertisement:

Advertisers can upload their own placement, audio, commercial ad or use easy-to-use production software to create their own audio and or visual commercials.

### Targeting a Campaign:

These campaigns can be targeted to listeners in the various ways described below.

City(s); State(s); Zip Code(s); Mile Radius of specific Zip Code(s); Day(s) of week; Time(s) of day(s); Gender(s); Age Range; Interest; Browsing History; Type of music user(s) listen to.

### GEO Targeting:

Campaigns can be delivered to targeted listeners of specific geographical locations by IP address and/or GPS location from the users' mobile application and/or location information otherwise provided by a user, such as through a zip code.

### Managing Campaigns:

These campaigns can be easily managed, and tracked by the advertiser in the various ways below.

Pause; Amount of funds remaining; Add more funds; Update targeting characteristics described above; Analytics—Number of advertisements played, viewed, selected; Create new campaign.

### Costs:

Advertising models can be cost-per-view, cost-per-click, or cost-per-play. Cost to the advertiser depends on the length of audio/commercial ad, size of the campaign, how targeted the campaign is, as well as the day(s) and time of day the campaign is scheduled to run. Costs can fluctuate dependent upon the demand in that specific region, area, day(s) and time of day.

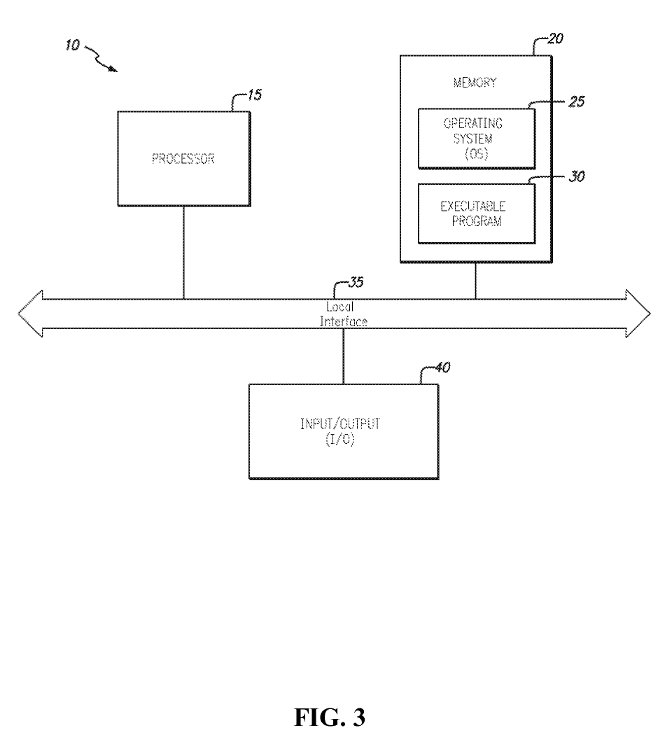

FIG. 3 is an exemplary embodiment of a target hardware (10) (e.g., a computer system) for implementing the embodiment of FIGS. 1 and 2. For example, a software implementing the methods of the present disclosure may be executed on a server computer which may be part of a server cluster. Such computers are known to the person skilled in the art. An example is given in FIG. 3. The target hardware as illustrated in FIG. 3 comprises a processor (15), a memory bank (20), a local interface bus (35) and one or more Input/output devices (40). The processor may execute one or more instructions related to the implementation of FIGS. 1 and 2, and as provided by the Operating System (25) based on some executable program (30) stored in the memory (20). These instructions are carried to the processor (15) via the local interface (35) and as dictated by some data interface protocol specific to the local interface and the processor (15). It should be noted that the local interface (35) is a symbolic representation of several elements such as controllers, buffers (caches), drivers, repeaters and receivers that are generally directed at providing address, control, and/or data connections between multiple elements of a processor based system. In some embodiments the processor (15) may be fitted with some local memory (cache) where it can store some of the instructions to be performed for some added execution speed. Execution of the instructions by the processor may require usage of some input/output device (40), such as inputting data from a file stored on a hard disk, inputting commands from a keyboard, inputting data and/or commands from a touchscreen, outputting data to a display, or outputting data to a USB flash drive. In some embodiments, the operating system (25) facilitates these tasks by being the central element to gathering the various data and instructions required for the execution of the program and provide these to the microprocessor. In some embodiments the operating system may not exist, and all the tasks are under direct control of the processor (15), although the basic architecture of the target hardware device (10) will remain the same as depicted in FIG. 3. In some embodiments a plurality of processors may be used in a parallel configuration for added execution speed. In such a case, the executable program may be specifically tailored to a parallel execution. Also, in some embodiments the processor (15) may execute part of the implementation of FIGS. 1 and 2, and some other part may be implemented using dedicated hardware/firmware placed at an Input/Output location accessible by the target hardware (10) via local interface (35). The target hardware (10) may include a plurality of executable programs (30), wherein each may run independently or in combination with one another.

The methods and systems described in the present disclosure may be implemented in hardware, software, firmware or any combination thereof. Features described as blocks, modules or components may be implemented together (e.g., in a logic device such as an integrated logic device) or separately (e.g., as separate connected logic devices). The software portion of the methods of the present disclosure may comprise a computer-readable medium which comprises instructions that, when executed, perform, at least in part, the described methods. The computer-readable medium may comprise, for example, a random access memory (RAM) and/or a read-only memory (ROM). The instructions may be executed by a processor (e.g., a digital signal processor (DSP), an application specific integrated circuit (ASIC), a field programmable logic array (FPGA), a graphic processing unit (GPU) or a general purpose GPU).

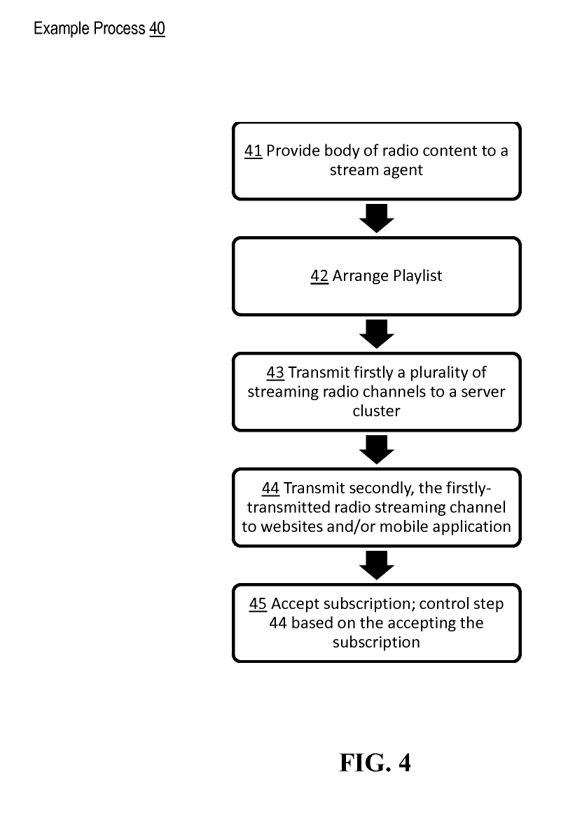

FIG. 4 depicts a flowchart for an example computer-implemented process 40 for streaming radio content. In step 41, a body of radio content is provided to a stream agent.

In step 42, a playlist is arranged with the stream agent. The playlist corresponds to one or more portions of the provided radio content body. The arranging the playlist step 42 may comprise optionally modifying at least one of the portions of the radio content body.

In step 43, the stream agent transmits firstly a plurality of streaming radio channels to a server cluster. Each of the plurality of streaming channels corresponds to one of the portions of the radio content body, based on the arranging the playlist step and comprising the optionally modified radio content body.

In step 44, the server cluster transmits second, the first-transmitted radio streaming channel to one or more of a website or mobile application. The one or more websites or mobile applications are configured to play the radio streaming channel.

One or more users of the radio content body provided with the stream agent (who may include at least one DJ) may perform the arrangement of the playlist. Optionally modifying the at least one radio content body portion may comprise filtering and/or mixing. The mixing may comprise a voice input and/or a fading effect into the body of radio content. The voice input may comprise a microphonically mixed input, which comprises an audio input related to at least one of the one or more users. The fading effects may comprise a fade-in effect and/or a fade-out effect.

Each of the radio content body portions may comprise a first component and a second component. The first radio content body component relates to a substantive audio, video, or mixed audio and video (AV) content portion. The second radio content body component relates to an auxiliary audio, video, or AV content portion, which is associated, at least in part, with the first substantive audio, video, or AV content portion in at least one of real time or near real time. The first, substantive radio content body component is associated with a genre, which relates to one or more of a music, discussion, news, talk, education, information, weather, sports, or entertainment.

The second, auxiliary audio, video or AV content portion comprises at least one of an advertisement or a commentary, which corresponds to the first, substantive radio content body component.

The process 40 may further comprise a step 45 in which a subscription is accepted, e.g., in exchange for valuable consideration such as a subscription fee or the like, to a radio channel comprising the optionally modified radio content body. The second-transmitting step 44 may be controlled, at least in part, based on the accepting the subscription.

The optional modification of the radio content body may comprise removing at least a portion of one or more of the radio content body in response to the accepting the subscription. For example, paying for a subscription may make content available free of an advertisement (ad). Thus, modification may relate to the removal of the ad related portions of the content.

An example embodiment of the present disclosure relates to a computer network based system for streaming radio content. The system comprises a provider component operable for providing a body of radio content and a stream agent.

The stream agent is operable for receiving the provided radio content body, for arranging a playlist corresponding to one or more portions of the received radio content body wherein the stream agent, while operating to arrange the playlist, is further operable for optionally modifying at least one of the portions of the received radio content body, and for first-transmitting a plurality of streaming radio channels, each of the plurality of streaming radio channels based on the playlist arranged in relation to the corresponding radio content portion and comprising the optionally modified radio content body.

The system also comprises a plurality of servers, which are arranged as a cluster. The server cluster is operable for receiving the first-transmitted plurality of streaming radio channels and for second-transmitting each of the streaming radio channels to one or more of a website or mobile application, wherein the one or more websites or mobile applications are configured to play one or more of the streaming radio channels.

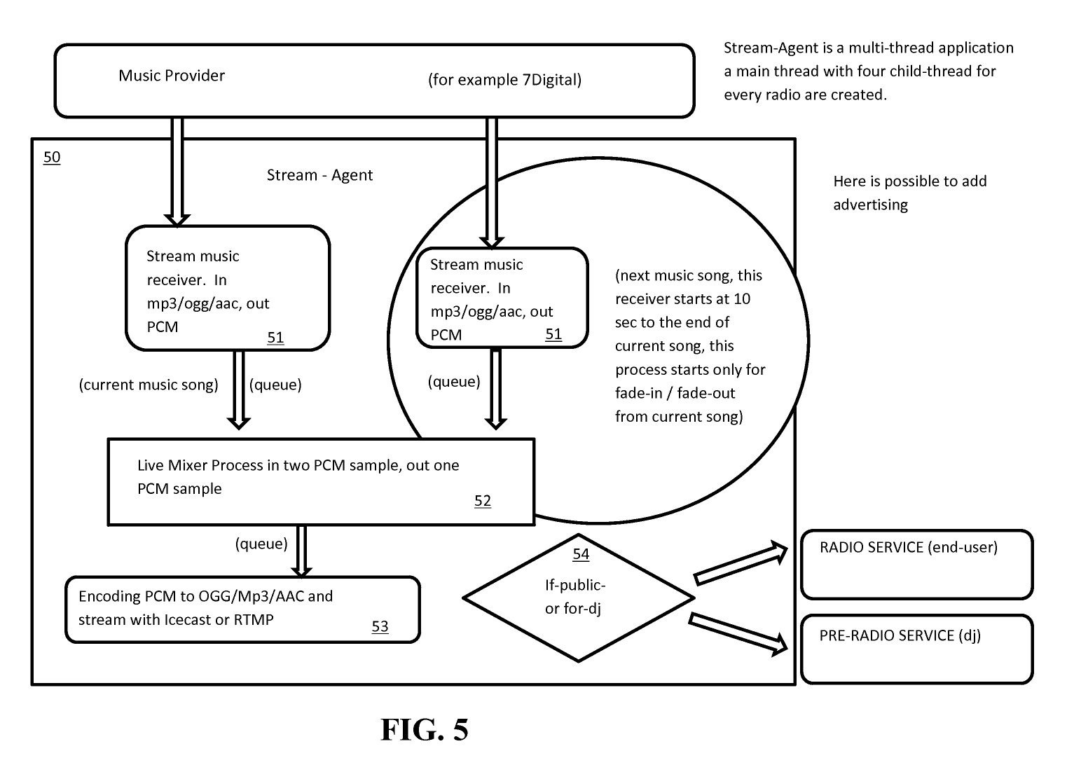

FIG. 5 depicts an example stream agent 50, according to an embodiment of the present disclosure. The stream agent 50 may comprise an application operable for processing a plurality of threads corresponding to each of the streaming radio channels. Each of plurality of threads comprises at least one main thread and four threads based on the at least one main thread.

The stream agent 50 comprises a receiver 51, which is operable for processing an input comprising at least one of a plurality of lossy audio codecs, for queueing simultaneously a first of the received radio content body portions, the first received radio content body portion corresponding to a first stream time, and at least a second of the received radio content body portions, the second received radio content body portion corresponding to a second stream time, which is displaced temporally in relation to the first stream time, and for generating a first pulse code modulation (PCM) signal and at least a second PCM signal corresponding respectively to the first and the at least second radio content body portions.

The stream agent 50 also comprises a live mixer process 52 operable for mixing the first PCM signal and the second PCM signal and for outputting a correspondingly mixed PCM signal. The stream agent 50 further comprises an encoder 53 operable for compressing audio data corresponding to the mixed PCM signal based on one or more of the lossy audio codecs.

Further still, the stream agent 50 also comprises a transmitter 54 operable for streaming an output signal based on the compressed audio data. The first stream time is current in relation to real time and the at least second stream time is subsequent in relation to the first stream time.

The system may further comprise a radio service comprising a content delivery network (CDN) and operable for broadcasting the second-transmitted streaming radio channels from the server cluster to the one or more websites or mobile applications, wherein the one or more websites or mobile applications are configured to communicatively couple with the CDN.

The system may further comprise a pre-radio service operable for receiving the first-transmitted plurality of streaming radio channels and for presenting the received first-transmitted plurality of streaming radio channels for a processing application, and an SPM engine operable for accessing the presented firstly-transmitted plurality of streaming radio channels and performing the processing application thereon.

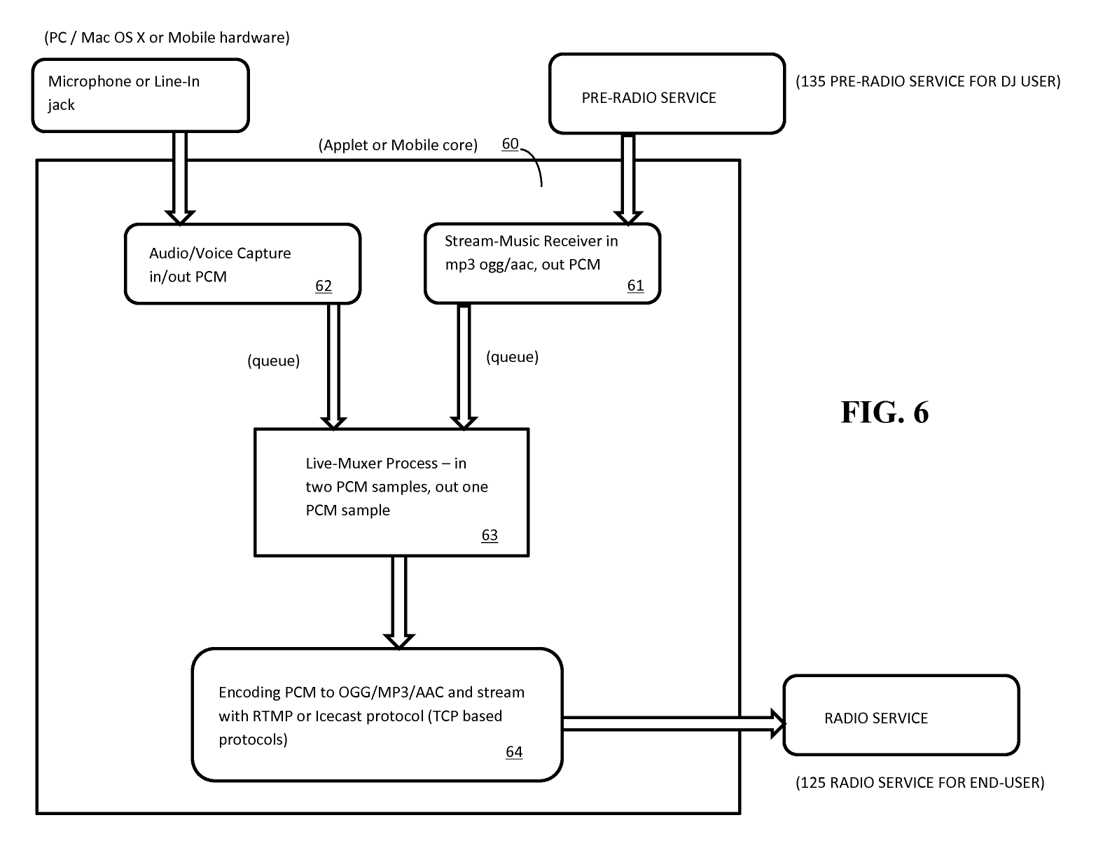

FIG. 6 depicts an example SPM engine (in this example, configured using an applet) 60, according to an embodiment of the present disclosure. The SPM engine 60 comprises a receiver 62 operable for receiving a live microphonic audio input captured in real time relative to at least one of the accessed streaming radio channels and for generating a first PCM based data signal corresponding to the captured microphonic audio input.

In an example embodiment, the SPM engine 60 comprises code related to a Java® Applet. The code for the SPM engine 60 may also be written in JavaScript®, such as a JavaScript® program, which leverages a Web Audio Data API. The SPM engine 60 may also comprise code native to PCs (e.g., desktops and other computers) and/or mobile (e.g., smart phones, etc.), tablet and similar computer devices.

The processing application performed by the SPM engine 60 comprises an example decoder 61, which is operable for decoding the accessed streaming audio channels into a corresponding second PCM based data signal.

The processing application performed by the SPM Engine 60 comprises a live mixer process 63, which is operable for mixing the first and the second PCM based data signals into a mixed PCM data signal.

The processing application performed by the SPM Engine 60 comprises an encoder 64, which is operable for encoding the mixed PCM data signal based on at least one of the lossy audio codecs wherein a modified radio stream corresponding to the mixed PCM data signal is generated, and pushing the modified radio stream to the radio service wherein at least one of the second-transmitted streaming radio channels is based on the modified audio stream.

At the top of its infrastructure, the server cluster comprises at least one application program interface (API) Server layer. The API-Server may be operable to perform social sharing and other functions. The stream action related operations of the API-Server comprises management and updating of playlists and DJs and other users, which may be stored on MongoDB or another database.

The server is operable for performing searches on Songs, Albums, Artists and DJs, e.g., using Elasticsearch or a search engine application. The API-Server manages the status of Radio/Set/Playlist via as Representational State Transfer (REST) API. For control over all Stream-Agent nodes for start-stop operations about every single Radio, communication between API-Server and the Stream-Agent may be based on distributed queue and shared objects, and on web services.

An example embodiment may be implemented in which one or more stream agent layers in the server cluster are under the control of the API-Server. Each of the stream agents is controlled by the API-Server layer by distributed queue and shared object, and web services. Stream-Agents get information relating to the provider's location stream URL from a call (REST) to the Api-Server layer. Stream agents make a direct call to the provider's service to get the stream of music (a song) or other content, to be put into a radio service for delivery to DJs and/or end user listeners.

The Stream-Agent streams the music to Radio-Service (for end user listeners) or Pre-Radio Service (wherein the DJ is the listener). The Stream-Agent may execute an entire playlist or a list of playlists individually. The stream agent may receive the playlist or list of playlists from a queue. Stream-Agent can receive a skip song command from a queue. The status of each queue of each of the single Radio/Sets is updated in real-time on the API-Server.

Each of the clients connected to the API-Server receives the status update, if necessary, by websocket (e.g., using a push update). An example embodiment may be implemented wherein the music/stream content from the providers is not recorded, but instead, each of the streams is handled live (e.g., from provider, from microphone, sound signal operation, and result streaming).

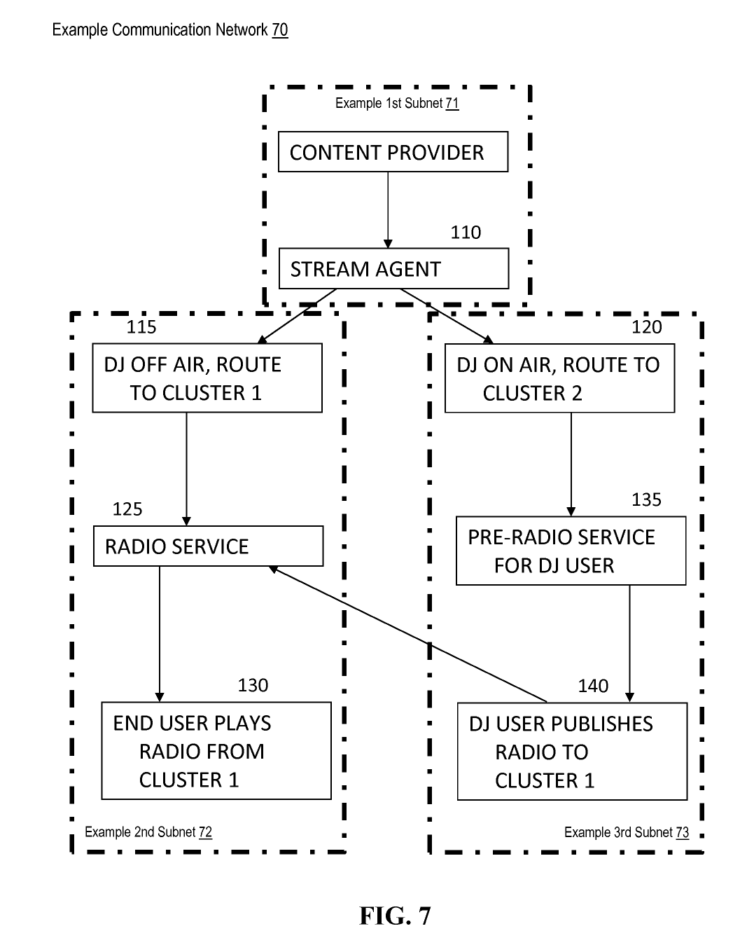

An example embodiment of the present application relates to a communication network configured for streaming radio content. FIG. 7 depicts an example communication network 70, according to an embodiment of the present disclosure.

The communication network 70 comprises a first subnet (sub-network) 71, a second subnet 72 and a third subnet 73. The first subnet 71 comprises a content provider operable for providing a body of radio content and a stream agent communicatively coupled thereto and operable for receiving the provided radio content body, for arranging a playlist corresponding to one or more portions of the received radio content body. The stream agent, while operating to arrange the playlist, is further operable for optionally modifying at least one of the portions of the received radio content body, and for first-transmitting a plurality of streaming radio channels, each of the plurality of streaming radio channels based on the playlist arranged in relation to the corresponding radio content portion and comprising the optionally modified radio content body.

The second subnet 72 comprises a first plurality of servers arranged in a cluster and a radio service. The second subnet 72 is operable for broadcasting a plurality of streaming radio channels, each corresponding to at least one of the radio content body portions, to one or more websites or mobile applications, the one or more websites or mobile applications configured to play one or more of the streaming radio channels.

The third subnet 73 comprises a second plurality of servers arranged in a cluster and a pre-radio service. The third subnet 73 is operable for modifying one or more of the streaming radio channels with an optional modification added by a user of the third subnet 73 in at least near real time relative to the one or more streaming radio channels. The third subnet 73 is further operable for providing the optionally modified streaming radio channels to the second subnet 72.

An example embodiment of the present disclosure is thus described in relation to a computer-implemented method for streaming radio content. The method comprises providing a body of radio content to a stream agent. A playlist is arranged with the stream agent. The playlist corresponds to one or more portions of the provided radio content body, wherein the arranging the playlist step comprises optionally modifying at least one of the portions of the radio content body. The stream agent transmits first a plurality of streaming radio channels to a server cluster. Each of the plurality of streaming channels corresponds to one of the portions of the radio content body, based on the arranging the playlist step and comprising the optionally modified radio content body. The server cluster transmits second the first-transmitted radio streaming channel to one or more of a website or mobile application. The one or more websites or mobile applications are configured to play the radio streaming channel. One or more users of the radio content body provided with the stream agent (who may include at least one DJ) may perform the arrangement of the playlist.

Optionally modifying the at least one radio content body portion may comprise filtering and/or mixing. The mixing may comprise a voice input and/or a fading effect into the body of radio content. The voice input may comprise a microphonically mixed input, which comprises an audio input related to at least one of the one or more users. The fading effects may comprise a fade-in effect and/or a fade-out effect.

Each of the radio content body portions may comprise a first component and a second component. The first radio content body component relates to a substantive audio, video, or mixed audio and video (AV) content portion. The second radio content body component relates to an auxiliary audio, video, or AV content portion, which is associated, at least in part, with the first substantive audio, video, or AV content portion in at least one of real time or near real time. The first, substantive radio content body component is associated with a genre, which relates to one or more of a music, discussion, news, talk, education, information, weather, sports, or entertainment. The second, auxiliary audio, video or AV content portion comprises at least one of an advertisement or a commentary, which corresponds to the first, substantive radio content body component.

The method may further comprise accepting a subscription to a radio channel comprising the optionally modified radio content body. The second-transmitting step may be controlled, at least in part, based on the accepting the subscription. The optional modification of the radio content body may comprise removing at least a portion of one or more of the radio content body in response to the accepting the subscription. For instance, paying for a subscription may make content available free of advertisements. Thus, modification may relate to the removal of the ad related portions of the content.

An example embodiment of the present disclosure has been described in relation to a computer network based system for streaming radio content. The system comprises a provider component operable for providing a body of radio content and a stream agent. The stream agent is operable for receiving the provided radio content body, for arranging a playlist corresponding to one or more portions of the received radio content body wherein the stream agent, while operating to arrange the playlist, is further operable for optionally modifying at least one of the portions of the received radio content body, and for first-transmitting a plurality of streaming radio channels, each of the plurality of streaming radio channels based on the playlist arranged in relation to the corresponding radio content portion and comprising the optionally modified radio content body. The system also comprises a plurality of servers arranged as a cluster. The server cluster is operable for receiving the first-transmitted plurality of streaming radio channels and for second-transmitting each of the streaming radio channels to one or more of a website or mobile application, wherein the one or more websites or mobile applications are configured to play one or more of the streaming radio channels.

The stream agent may comprise an application operable for processing a plurality of threads corresponding to each of the streaming radio channels. Each of a plurality of threads comprises at least one main thread, and four threads based on the at least one main thread. The stream agent may also comprise a receiver operable for processing an input comprising at least one of a plurality of lossy audio codecs, for queueing simultaneously a first of the received radio content body portions, the first received radio content body portion corresponding to a first stream time, and at least a second of the received radio content body portions, the second received radio content body portion corresponding to a second stream time, which is displaced temporally in relation to the first stream time, and for generating a first pulse code modulation (PCM) signal and at least a second PCM signal corresponding respectively to the first and the at least second radio content body portions. The stream agent may also comprise a live mixer process operable for mixing the first PCM signal and the second PCM signal and for outputting a correspondingly mixed PCM signal, an encoder operable for compressing audio data corresponding to the mixed PCM signal based on one or more of the lossy audio codecs, and a transmitter operable for streaming an output signal based on the compressed audio data. The first stream time is current in relation to real time and the at least second stream time is subsequent in relation to the first stream time.

The system may further comprise a radio service comprising a content delivery network (CDN) and operable for broadcasting the second-transmitted streaming radio channels from the server cluster to the one or more websites or mobile applications, wherein the one or more websites or mobile applications are configured to communicatively couple with the CDN.

The system may further comprise a pre-radio service operable for receiving the first-transmitted plurality of streaming radio channels and for presenting the received first-transmitted plurality of streaming radio channels for a processing application, and an SPM Engine operable for accessing the presented first-transmitted plurality of streaming radio channels and performing the processing application thereon. The SPM Engine may be further operable for receiving a live microphonic audio input captured in real time relative to at least one of the accessed streaming radio channels and for generating a first PCM based data signal corresponding to the captured microphonic audio input. The processing application performed by the SPM Engine may comprise decoding the accessed streaming audio channels into a corresponding second PCM based data signal, mixing the first and the second PCM based data signals into a mixed PCM data signal, encoding the mixed PCM data signal based on at least one of the lossy audio codecs wherein a modified radio stream corresponding to the mixed PCM data signal is generated, and pushing the modified radio stream to the radio service wherein at least one of the second-transmitted streaming radio channels is based on the modified audio stream.

An example embodiment of the present disclosure has been described in relation to a communication network configured for streaming radio content. The communication network comprises a first subnet, a second subnet and a third subnet. The first subnet comprises a content provider operable for providing a body of radio content and a stream agent communicatively coupled thereto and operable for receiving the provided radio content body, for arranging a playlist corresponding to one or more portions of the received radio content body. The stream agent, while operating to arrange the playlist, is further operable for optionally modifying at least one of the portions of the received radio content body, and for first-transmitting a plurality of streaming radio channels, each of the plurality of streaming radio channels based on the playlist arranged in relation to the corresponding radio content portion and comprising the optionally modified radio content body.

The second subnet comprises a first plurality of servers arranged in a cluster and a radio service. The second subnet is operable for broadcasting a plurality of streaming radio channels, each corresponding to at least one of the radio content body portions, to one or more websites or mobile applications, the one or more websites or mobile applications configured to play one or more of the streaming radio channels.

The third subnet comprises a second plurality of servers arranged in a cluster and a pre-radio service. The third subnet is operable for modifying one or more of the streaming radio channels with an optional modification added by a user of the third subnet in at least near real time relative to the one or more streaming radio channels. The third subnet is further operable for providing the optionally modified streaming radio channels to the second subnet.

Methods for broadcasting radio are disclosed. Radio content may comprise music, video, audio and talk shows. A radio stream may be transmitted to end users or may be first transmitted to a DJ and then subsequently to end users. Radio streams may be available through radio stream websites.

Streaming radio content includes providing radio content to a stream agent. A playlist is arranged corresponding to the content, which includes optionally modifying portions thereof The stream agent transmits firstly, multiple streaming radio channels to a server cluster, each of which corresponds to part of the content, based on the arranged playlist and including the optionally modified content. The server cluster transmits secondly, the first-transmitted radio streaming channel to websites and/or mobile applications, which are configured to play it. A DJ may modify the content and arrange the playlist.

An example embodiment of the present disclosure may relate to a first method to stream radio content. The first method may comprise providing, by a computer, radio content to a stream agent; arranging, by the stream agent, a playlist with the provided radio content; transmitting, by the stream agent, a radio streaming channel to a server cluster, wherein the radio streaming channel is based on the arranged playlist; and transmitting, by the server cluster, the radio streaming channel to a website or mobile application, wherein the website or mobile application is configured to play the radio streaming channel. The playlist comprises at least one as described in: musical content, talk shows, video content and advertisements. The radio content may be mixed or filtered. The radio content comprises advertisements, which may be geo-targeted.

An example embodiment of the present disclosure may relate to a second method to stream radio content. The second method may comprise providing, by a computer, radio content to a stream agent; arranging, by the stream agent, a playlist with the radio content; transmitting, by the stream agent, a radio streaming channel to a pre-radio server cluster, wherein the radio streaming channel is based on the playlist, and wherein the pre-radio server cluster is configured to allow insertion of content from a disc jockey; transmitting, by the pre-radio server cluster, the radio streaming channel to a server cluster; and transmitting, by the server cluster, the radio streaming channel to a website, wherein the website is configured to play the radio streaming channel for end users. The playlist comprises at least one of: musical content, talk shows, video content and advertisements. The radio content may be mixed or filtered. The radio content may comprise advertisements, which may be geo-targeted. The DJ may charge the end users for listening to the radio streaming channel on a monthly subscription model or a pay-per-listen model.

An example embodiment of the present disclosure may relate to a third method to stream radio content. The third method may comprise providing, by a computer, radio content to a stream agent; arranging, by the stream agent, a playlist with the radio content. If the radio content is for a radio streaming channel with no DJ, then the third method may comprise transmitting, by the stream agent, the radio streaming channel to a first server cluster, wherein the radio streaming channel is based on the playlist. If the radio content is for a radio streaming channel with a DJ, then the third method may comprise transmitting, by the stream agent, the radio streaming channel to a pre-radio server cluster, wherein the radio streaming channel is based on the playlist, and wherein the pre-radio server cluster is configured to allow insertion of content from a DJ; transmitting, by the pre-radio server cluster, the radio streaming channel to a server cluster; and transmitting, by the server cluster, the radio streaming channel to a website, wherein the website is configured to play the radio streaming channel.

Thus, example embodiments of the present disclosures have been described in relation to methods, systems and communication networks operable for streaming radio content. The method, for instance, comprises providing a body of radio content to a stream agent. A playlist is arranged with the stream agent. The playlist corresponds to one or more portions of the provided radio content body, wherein the arranging the playlist step comprises optionally modifying at least one of the portions of the radio content body. The stream agent transmits first a plurality of streaming radio channels to a server cluster. Each of the plurality of streaming channels corresponds to one of the portions of the radio content body, based on the arranging the playlist step and comprising the optionally modified radio content body. The server cluster transmits second the first-transmitted radio streaming channel to one or more of a website or mobile applications. The one or more websites or mobile applications are configured to play the radio streaming channel. One or more users of the radio content body provided with the stream agent (who may include at least one DJ) may perform the arrangement of the playlist.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure, and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a,” an and the include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

What is claimed is:

1. A computer-implemented method for streaming radio content, the method comprising the steps of:
a) providing a body of radio content to a stream agent;
b) arranging, with the stream agent, a playlist corresponding to one or more portions of the provided radio content body, wherein the arranging the playlist step comprises optionally modifying at least one of the portions of the radio content body;
c) first-transmitting, with the stream agent, a plurality of streaming radio channels to a server cluster, each of the plurality of streaming channels corresponding to one of the portions of the radio content body, based on the arranging the playlist step and comprising the optionally modified radio content body; and
d) second-transmitting, with the server cluster, the first-transmitted radio streaming channel to one or more of a website or mobile application, wherein the one or more websites or mobile applications are configured to play the radio streaming channel.

2. The method as described in claim 1 wherein one or more users of the radio content body provided with the stream agent performs the arranging step b).

3. The method as described in claim 1 wherein one or more users of the radio content body provided with the stream agent comprises at least one disk jockey (DJ).

4. The method as described in claim 1 wherein the optionally modifying step comprises one or more of filtering or mixing, the mixing comprising one or more of a voice input or a fading effect into the body of radio content.

5. The method as described in claim 4 wherein the voice input comprises a microphonically mixed input, which comprises an audio input related to at least one of the one or more users.

6. The method as described in claim 4 wherein the fading effect comprises one or more of a fade-in effect or a fade-out effect.

7. The method as described in claim 1 wherein each of the radio content body portions comprises a first component and a second component.

8. The method as described in claim 7 wherein the first radio content body component relates to a substantive audio, video, or mixed audio and video (AV) content portion and wherein the second radio content body component relates to an auxiliary audio, video, or AV content portion, which is associated, at least in part, with the first substantive audio, video, or AV content portion in at least one of real time or near real time.

9. The method as described in claim 8 wherein the first, substantive radio content body component is associated with a genre, which relates to one or more of a music, discussion, news, talk, education, information, weather, sports, or entertainment.

10. The method as described in claim 8 wherein the second, auxiliary audio, video or AV content portion comprises at least one of an advertisement or a commentary, which corresponds to the first, substantive radio content body component.

11. The method as described in claim 1 further comprising the step of:
e.) accepting a subscription to a radio channel comprising the optionally modified radio content body, wherein the second-transmitting step d.) is controlled based, at least in part, on the accepting the subscription.

12. The method as described in claim 11 wherein the step of optionally modifying the radio content body comprises removing at least a portion of one or more of the radio content body in response to the accepting the subscription step e).

13. A computer network based system for streaming radio content, the system comprising:
a provider component operable for providing a body of radio content;
a stream agent operable for receiving the provided radio content body, for arranging a playlist corresponding to one or more portions of the received radio content body wherein the stream agent, while operating to arrange the playlist, is further operable for optionally modifying at least one of the portions of the received radio content body, and for first-transmitting a plurality of streaming radio channels, each of the plurality of streaming radio channels based on the playlist arranged in relation to the corresponding radio content portion and comprising the optionally modified radio content body; and
a plurality of servers arranged as a cluster, the server cluster operable for receiving the first-transmitted plurality of streaming radio channels and for second-transmitting each of the streaming radio channels to one or more of a website or mobile application, wherein the one or more websites or mobile applications are configured to play one or more of the streaming radio channels.

14. The system as described in claim 13 wherein the stream agent comprises an application operable for processing a plurality of threads corresponding to each of the streaming radio channels.

15. The system as described in claim 14 wherein the each of plurality of threads comprises at least one main thread and four threads based on the at least one main thread.

16. The system as described in claim 13 wherein the stream agent comprises:
a receiver operable for processing an input comprising at least one of a plurality of lossy audio codecs, for queueing simultaneously a first of the received radio content body portions, the first received radio content body portion corresponding to a first stream time, and at least a second of the received radio content body portions, the second received radio content body portion corresponding to a second stream time, which is displaced temporally in relation to the first stream time, and for generating a first pulse code modulation (PCM) signal and at least a second PCM signal corresponding respectively to the first and the at least second radio content body portions;
a live mixer process operable for mixing the first PCM signal and the second PCM signal and for outputting a correspondingly mixed PCM signal;
an encoder operable for compressing audio data corresponding to the mixed PCM signal based on one or more of the lossy audio codecs; and
a transmitter operable for streaming an output signal based on the compressed audio data.

17. The system as described in claim 16 wherein the first stream time is current in relation to real time and wherein the at least second stream time is subsequent in relation to the first stream time.

18. The system as described in claim 13 further comprising a radio service comprising a content delivery network (CDN) and operable for broadcasting the second-transmitted streaming radio channels from the server cluster to the one or more websites or mobile applications, wherein the one or more websites or mobile applications are configured to communicatively couple with the CDN.

19. The system as described in claim 18 further comprising:
a pre-radio service operable for receiving the first-transmitted plurality of streaming radio channels and for presenting the received first-transmitted plurality of streaming radio channels for a processing application; and
an SPM Engine operable for accessing the presented first-transmitted plurality of streaming radio channels and performing the processing application thereon;
wherein the SPM Engine comprises one or more of Java® based code, a Java® Applet, code native to a computer platform, code native to a mobile platform, or JavaScript® operable with an application program interface (API), wherein the API is related to Web Audio Data.

20. The system as described in claim 19 wherein the SPM Engine is further operable for receiving a live microphonic audio input captured in real time relative to at least one of the accessed streaming radio channels and for generating a first pulse code modulation (PCM) based data signal corresponding to the captured microphonic audio input and wherein the processing application performed by the SPM Engine comprises:
decoding the accessed streaming audio channels into a corresponding second PCM based data signal;
mixing the first and the second PCM based data signals into a mixed PCM data signal;
encoding the mixed PCM data signal into based on at least one of the lossy audio codecs wherein a modified radio stream corresponding to the mixed PCM data signal is generated; and
pushing the modified radio stream to the radio service wherein at least one of the second-transmitted streaming radio channels is based on the modified audio stream.

21. A communication network configured for streaming radio content, the communication network comprising:
a first subnet comprising a content provider operable for providing a body of radio content and a stream agent communicatively coupled thereto and operable for receiving the provided radio content body, for arranging a playlist corresponding to one or more portions of the received radio content body wherein the stream agent, while operating to arrange the playlist, is further operable for optionally modifying at least one of the portions of the received radio content body, and for first-transmitting a plurality of streaming radio channels, each of the plurality of streaming radio channels based on the playlist arranged in relation to the corresponding radio content portion and comprising the optionally modified radio content body;
a second subnet comprising a first plurality of servers arranged in a cluster and a radio service, the second subnet operable for broadcasting a plurality of streaming radio channels, each corresponding to at least one of the radio content body portions, to one or more websites or mobile applications, the one or more websites or mobile applications configured to play one or more of the streaming radio channels; and
a third subnet comprising a second plurality of servers arranged in a cluster and a pre-radio service, the third subnet operable for modifying one or more of the streaming radio channels with an optional modification added by a user of the third subnet in at least near real time relative to the one or more streaming radio channels and for providing the optionally modified streaming radio channels to the second subnet.
